(19) United States
(12) Patent Application Publication
(10) Pub. No.: US 2009/0286671 A1
(43) Pub. Date: Nov. 19, 2009

(54) Process for Preparing a Support for Olefin Polymerization Catalysts

(75) Inventors: Christoph Kiener, Weisenheim (DE); Ingo Treffkorn, Dudenhofen (DE); Guido Funk, Worms (DE)

Correspondence Address: LyondellBasell Industries, 3801 WEST CHESTER PIKE, NEWTOWN SQUARE, PA, 19073, US

(73) Assignee: Basell Polyolefine GmbH, Wesseling (DE)

(21) Appl. No.: 12/086,464

(22) PCT Filed: Dec. 4, 2006
(86) PCT No.: PCT/EP2006/011598

§ 371 Date: Jun. 12, 2008

Related U.S. Application Data
(60) Provisional application No. 60/762,979, filed on Jan. 27, 2006.

(30) Foreign Application Priority Data
Dec. 16, 2005 (DE) 102005060771.3

(51) Int. Cl. B01J 29/04

(52) U.S. Cl. 502/87

(57) ABSTRACT

The invention relates to a process for preparing an essentially spherical support for olefin polymerization catalysts, which comprises the steps: preparation of a hydrogel comprising a cogel of silicon oxide and at least one further metal oxide, if appropriate, washing of the hydrogel until the content of alkali metal ions is less than 0.1% by weight, based on the weight of solids, extraction of the water from the hydrogel until the water content is less than 5% by weight, based on the total content of liquid, and drying of the hydrogel to form a xerogel. According to the invention, the extraction step comprises at least one batchwise extraction with an organic solvent which is at least partially miscible with water down to a water content of less than 50% by weight, followed by at least one continuous extraction with an organic solvent which is at least partially miscible with water.

The invention relates to a process for preparing an essentially spherical support for olefin polymerization catalysts, which comprises the steps
a) preparation of a hydrogel comprising a cogel of silicon oxide and at least one further metal oxide,
b) if appropriate, washing of the hydrogel until the content of alkali metal ions is less than 0.1% by weight, based on the weight of solids,
c) extraction of the water from the hydrogel until the water content is less than 5% by weight, based on the total content of liquid, and
d) drying of the hydrogel to form a xerogel.

Silica gels are the starting material for the preparation of Phillips catalysts for the polymerization of olefins. Important polymer parameters such as the melt flow rate (MFR₂₁) or the intrinsic viscosity and also important process parameters such as formation of fine dust or the bulk density of the polymer depend critically on the support material used.

Supports based on silica gel are usually prepared by firstly preparing a hydrogel in a gel formation process, subjecting this to an appropriate aging process, washing it with water and subsequently extracting the water by means of solvents having a lower surface tension or adding detergents to the water, before final milling, sieving and impregnation takes place.

Since the gel comprises a rigidly crosslinked, three-dimensional network of particles or short particle chains, it is clear that the network will collapse when the gel is dried. This is attributable to the high surface tension of the water present in the pores. It is therefore usual to replace the water by other solvents before drying or add detergents to the water in order to obtain a product having a high pore volume. Since a large pore volume is of critical importance for the quality of the supported catalyst, the extraction step is also of considerable importance. An overview of this may be found in “The Chemistry of Silica” by Ralph K. Iler, John Wiley & Sons, New York, 1979, pages 510-554.

US 2003/0065112 A1 discloses the use of hexanol as extractant to remove the water from the particles by azeotropic distillation at 170° C. According to U.S. Pat. No. 5,372,983, the gel which has been treated with a C5-C6-alcohol is partially oxidized at 450-700° C. A disadvantage of this is the large quantity of energy required for the distillation or oxidation.

In WO 93/23438 A1, it is stated that the extraction of the gel is preferably carried out using isopropanol. The extraction of the gel is carried out batchwise in this case by slurrying of 100 parts of hydrogel with 100 parts of solvent, preferably isopropanol, with the procedure being carried out at least three times, preferably five times, but in any case as often as necessary for the water content to be less than 25%.

DE 25 40 279 A1 discloses a process for the extraction of the water from the gel, in which ethanol is continuously introduced at constant rate into and allowed to flow out of an extraction vessel provided with a screen bottom until the outflowing ethanol/water mixture has reached a prescribed density, i.e. a particular water content.

A disadvantage of the processes mentioned is that the extraction times are quite long. In the extraction of cogels in particular, the extraction time increases significantly with increasing content of foreign metal such as Ti for a constant pore volume.

It is therefore an object of the present invention to provide a process for preparing supports for olefin polymerization catalysts, by means of which the extraction times for a constant quality of the supports can be shortened or the quality of the products can be improved for the same extraction times. A further object of the present invention is to minimize the consumption of solvents. Another object of the present invention is to minimize the energy consumption during the extraction.

This object is achieved according to claim 1 by the extraction step c) comprising
(1) at least one batchwise extraction with an organic solvent which is at least partially miscible with water down to a water content of less than 50% by weight, followed by
(2) at least one continuous extraction with an organic solvent which is at least partially miscible with water.

According to the invention, at least one batchwise extraction and a continuous extraction are carried out in each case, with the continuous extraction being carried out after the batchwise extraction. Preference is given to carrying out more than 2, more preferably more than 3, particularly preferably more than 5, batchwise extractions in step (1). The number of continuous extractions does not have an upper limit, but more than 10 extractions offer little advantage. In step (2), preference is given to carrying out not more than two continuous extractions, particularly preferably a single continuous extraction. In a particularly preferred embodiment, from 2 to 5 batchwise extractions are carried out in step (1) and one continuous extraction is carried out in step (2).

The batchwise extractions preferably each have a duration of from 30 seconds to 1 hour, more preferably from 1 minute to 40 minutes, more preferably from 2 minutes to 30 minutes, particularly preferably from 3 minutes to 20 minutes. The duration preferably increases from the first to the last batchwise extraction. The total duration of the batchwise extractions should not exceed 5 hours, preferably 3 hours. The continuous extractions preferably each have a duration of from 5 minutes to 5 hours, more preferably from 10 minutes to 4 hours, more preferably from 15 minutes to 3 hours, particularly preferably from 20 minutes to 2 hours, but in any case until the desired final water content has been reached. The total duration of the continuous extractions should not exceed 5 hours, preferably 3 hours.

The solvents for the batchwise and continuous extractions can be identical or different.

Suitable solvents are generally all polar organic protic or aprotic polar solvents as long as they are at least partially miscible with water. In the case of liquids which are not completely miscible with water, the miscibility of the solvent should be above 1 g, preferably above 2 g, particularly preferably above 5 g, per 100 ml of water in order to achieve satisfactory extraction. The first and second organic solvents should likewise be at least partially, preferably completely, miscible with one another. Particular preference is given to organic protic solvents. Preference is given to at least the first organic solvent being completely miscible with water. Particular preference is given to both organic solvents being completely miscible with water. Mixtures of various solvents can also be used, but the use of only one pure organic solvent is preferred. The solvent is preferably a saturated organic liquid comprising heteroatoms of groups 15, 16 and 17.

In a preferred embodiment, the boiling point of the organic solvents is less than or equal to 150° C., preferably less than or equal to 100° C., particularly preferably less than or equal to 80° C., so that they can be easily recovered by distillation. The recovery can also be made easier by the solvent not forming an azeotrope with water.

Protic solvents are, for example, alcohols R¹—OH, amines NR¹₂₋ₓHₓ₊₁, C₁-C₅-carboxylic acids or mixtures thereof, preferably alcohols R¹—OH, where R¹ is C₁-C₂₀-alkyl, C₂-C₂₀-alkenyl, C₆-C₂₀-aryl, alkylaryl having from 1 to 10 carbon atoms in the alkyl radical and 6-20 carbon atoms in the aryl radical, or SiR²₃, where the radicals R² are each, independently of one another, C₁-C₂₀-alkyl, C₂-C₂₀-alkenyl, C₆-C₂₀-aryl, alkylaryl having from 1 to 10 carbon atoms in the alkyl radical and 6-20 carbon atoms in the aryl radical and x is 1 or 2. Aprotic solvents are, for example, ketones, ethers, esters and nitriles, without being restricted thereto.

As radicals R¹ or R², preference is given to using C₁-C₈-alkyl which may be linear or branched, e.g. methyl, ethyl, n-propyl, isopropyl, n-butyl, isobutyl, tert-butyl, n-pentyl, n-hexyl, n-heptyl, n-octyl, 5- to 7-membered cycloalkyl which may in turn be alkyl-substituted, e.g. cyclopropane, cyclobutane, cyclopentane, cyclohexane, cycloheptane, cyclooctane. The organic radicals R¹ and R² may also be substituted by halogens such as fluorine, chlorine or bromine. Preferred alcohols R¹—OH are methanol, ethanol, 1-propanol, 2-propanol, 1-butanol, 2-butanol, 1-pentanol, 2-pentanol, 1-hexanol, 2-ethylhexanol, 2,2-dimethylethanol and 2,2-dimethylpropanol, in particular methanol, ethanol, 1-propanol, 1-butanol, 1-pentanol, 1-hexanol and 2-ethylhexanol.

The first organic solvent and the second organic solvent are particularly preferably selected independently from among R¹OH, R²—CO—R³, R²—O—R³, where R¹ is C₁-C₆-alkyl and R², R³ are each, independently of one another, C₁-C₄-alkyl, with R₁ and R₂ each being able to be branched or unbranched.

Preference is given to a first organic solvent being used in the batchwise extraction (step 1) and a second organic solvent which is different from the first being used in the continuous extraction (step 2). As an alternative, it is possible to change the organic solvent either between the batchwise extractions or during the subsequent continuous extraction.

In a particularly preferred embodiment, a solvent which has at least one carbon atom more or at least one branch, including the heteroatoms, more than the solvent in the preceding batchwise extraction is used in the continuous extraction. In counting the branches, the branches formed by heteroatoms are also taken into account. As an illustrative example, 2-propanol has by definition one branch more than 1-propanol, since the oxygen atom represents a branch. Hydrogen atoms are not counted.

As a result of the combination of various solvents, supports having particularly large pore volumes are obtained despite short extraction times or the pore volume can be further significantly increased at the same extraction time. Large pore volumes in turn lead to catalysts having a particularly good performance. Since relatively short-chain and less branched solvents are usually cheaper, the main part of the water can be removed particularly inexpensively.

It has been found in this context that groups having a greater bulk lead to supports having higher pore volumes for the same residual water content. Without wishing to be tied to this theory, the more hydrophilic first organic solvent removes the main part of the water particularly quickly and effectively, while the second organic solvent ensures a large pore volume.

Furthermore, particular preference is given to the organic radicals R¹, R², R³ of the second organic solvent together having at least one, preferably at least two, more carbon atoms than the first organic solvent.

Particularly good results in terms of recoverability, time savings and costs are achieved when the first organic solvent is selected from among methanol, ethanol, isopropanol and n-propanol and the second organic solvent is selected from among isopropanol, n-propanol, n-butanol, isobutanol and t-butanol. Ideally, methanol is used in combination with isopropanol.

The second organic solvent particularly preferably has the same functional group(s) as the first organic solvent, i.e. the first and second organic solvents belong to a homologous series.

The batchwise extraction takes place, according to the invention, down to a water content of less than 50% by weight, preferably less than 20% by weight, more preferably less than 10% by weight, particularly preferably less than 5% by weight. The batchwise extraction preferably takes place down to a water content of more than 0.1% by weight, more preferably more than 0.5% by weight, more preferably more than 1% by weight, particularly preferably more than 2% by weight. In a particularly advantageous embodiment, the at least one batchwise extraction is carried out down to a water content of from 10 to 0.5% by weight.

The water content in the case of the batchwise extraction is based on the proportion of water in the extraction mixture immediately after separation from the hydrogel relative to the total extraction mixture.

The batchwise extraction of step (1) is preferably carried out as follows. The isolated particles are placed in an extraction vessel which is provided with an inlet at the top, a horizontal screen and an outlet connected to the underside of the extraction vessel. The liquid level in the extraction vessel is selected so that the hydrogel particles are completely covered with liquid. The charging process usually takes from 5 to 15 minutes. The system is then preferably allowed to stand for from 5 to 20 minutes. Particular preference is here given to starting with short times and increasing these on each repetition so that the duration of the batchwise extractions increases with decreasing water content. The organic solvent concerned is then pumped out. This process likewise usually takes from 5 to 15 minutes.

The batchwise extraction is followed by the continuous extraction. This is, according to the invention, carried out until a water content of less than 5% by weight has been reached. The continuous extraction is preferably carried out until a water content of less than 3% by weight, more preferably less than 2% by weight, more preferably less than 1% by weight, particular preferably less than 0.5% by weight, has been reached.

The water content in the case of the continuous extraction is based on the proportion of water in the eluate coming from the hydrogel to be extracted relative to the total eluate.

The continuous extraction of step (1) is preferably carried out as described in DE 25 40 279 A1. Here, the isolated particles are placed in an extraction vessel provided with an inlet at the top, a horizontal screen and a swan-neck-shaped overflow which is connected to the underside of the extraction vessel, and the liquid level in the extraction vessel is kept high enough for the hydrogel particles to be completely covered with liquid. The organic solvent concerned is then allowed to run in until the outflowing mixture of water and organic solvent has attained the desired water content.

The inflow rate of the organic solvent is preferably from 0.2 to 10 l/h per kilogram of hydrogel, particularly preferably from 0.5 to 5 l/kg/h.

The determination of the water content in the extraction solvent can be carried out by all known methods. It is preferably carried out by Karl-Fischer titration. The Karl-Fischer method is based on the oxidation of sulfur dioxide by iodine according to the following chemical reaction:

H₂O+I₂+SO₂+CH₃OH+3RN−>[RNH]SO4CH3+2[RNH]I

The titration can be followed volumetrically or calorimetrically. The advantage of the Karl-Fischer method is that both relatively large amounts and traces of water can be determined very precisely.

The density of the solvent mixture can also be employed for determining the water content.

In step a) of the process of the invention, a hydrogel is firstly prepared. The hydrogel comprises a cogel of silicon oxide and at least one further metal oxide. Preference is given to a cogel consisting of silicon oxide and at least one further metal oxide.

For the purposes of the present invention, the term “hydrogel” encompasses all hydrogels which are suitable for preparing supports and are based on silicon-comprising starting materials; the term “hydrogel” preferably refers to hydrogels based on silica. According to the invention, the hydrogels comprise a cogel with at least one further metal oxide. The proportion of the cogel is preferably more than 20% by weight, more preferably more than 50% by weight. Particular preference is given to the hydrogel consisting of a cogel.

The water content of the hydrogel is preferably at least 80% by weight, preferably at least 90% by weight, based on the total weight of the hydrogel.

The preparation of a silica hydrogel or cogel is preferably carried out by acidic or basic precipitation from water glass. The preparation of the hydrogel is preferably carried out by introducing a sodium or potassium water glass solution into a rotating stream of a mineral acid, e.g. sulfuric acid. The silica hydrosol formed is subsequently sprayed into a gaseous medium by means of a nozzle. The nozzle mouthpiece used here leads, after solidification of the hydrosol in the gaseous medium, to hydrogel particles having a mean particle size which can be varied in a range from, for example, 1 mm to 20 mm by choice of the nozzle. The hydrogel particles preferably have a mean particle size in the range from 2 mm to 10 mm, preferably in the range from 5 mm to 6 mm.

The hydrogel particles can be sieved and fractions having the preferred diameter can be isolated.

Apart from spraying of a hydrosol, other methods known from the prior art can likewise be used for preparing the hydrogel. For example, hydrogels, preferably silica hydrogels, which can be prepared in a manner known from the prior art, for example from silicon-comprising starting materials such as alkali metal silicates, alkyl silicates and/or alkoxysilanes, can likewise be used for preparing supports according to the invention.

The size of hydrogel particles which can be used can vary within a wide range, for example in a range from a few microns to a few centimeters. The size of hydrogel particles which can be used is preferably in the range from 1 mm to 20 mm, but hydrogel cakes can likewise be used. It can be advantageous to use hydrogel particles having a size of ≦6 mm. These are obtained, for example, as by-product in the production of granular supports.

The hydrogels which can be prepared in step a) are preferably largely spherical. Hydrogels which can be prepared in step a) also preferably have a smooth surface. Silica hydrogels which can be prepared in step a) preferably have a solids content in the range from 10% by weight to 25% by weight, more preferably in the region of 17% by weight, calculated as SiO₂.

Step a) can optionally be followed by milling of the hydrogel to a finely particulate hydrogel. Here, preference is given to at least 5% by volume of the particles, based on the total volume of the particles, having a particle size in the range from >0 μm to ≦3 μm; and/or at least 40% by volume of the particles, based on the total volume of the particles, having a particle size in the range from >0 μm to ≦12 μm, and/or at least 75% by volume of the particles, based on the total volume of the particles, having a particle size in the range from >0 μm to ≦35 μm. Preference is here given to producing a finely particulate hydrogel having a solids content in the range from >0% by weight to ≦25% by weight, preferably in the range from 5% by weight to 15% by weight, more preferably in the range from 8% by weight to 13% by weight, particularly preferably in the range from 9% by weight to 12% by weight, very particularly preferably in the range from 10% by weight to 11% by weight, calculated as oxide. Particular preference is given to producing a finely particulate silica hydrogel having a solids content in the range from >0% by weight to ≦25% by weight, preferably in the range from 5% by weight to 15% by weight, more preferably in the range from 8% by weight to 13% by weight, particularly preferably in the range from 9% by weight to 12% by weight, very particularly preferably in the range from 10% by weight to 11% by weight, calculated as SiO₂, in step b). The solids content is preferably adjusted by dilution, for example by addition of deionized water.

The milling of the hydrogel can be carried out in a suitable mill, for example a pin mill or an impingement plate mill; the hydrogel is preferably milled wet in a stirred ball mill. The milling of the hydrogel can be carried out in one step and/or in one mill or in a plurality of steps and/or various mills. Before the hydrogel is finely milled, the hydrogel can be subjected to preliminary comminution or preliminary milling.

According to the invention, the gel is a cogel with a further metal oxide. Suitable metal oxides are the oxides of the elements Mg, Ca, Sr, Ba, B, Al, P, Bi, Sc, Ti, V, Mn, Fe, Co, Ni, Cu, Zn, Zr, Nb, Mo, Ru, Rh, Pd, Hf, Ta and W and also, if appropriate, one or more activators. Preference is given to using an element selected from among Mg, Ca, B, Al, P, Ti, V, Zr and Zn. Further preference is given to the use of Ti, Zr or Zn. Particular preference is given to the use of Ti. The content of the elements mentioned in the hydrogel is preferably from 0.1 to 20% by weight, more preferably from 0.3 to 10% by weight, particularly preferably from 0.5 to 5% by weight.

In step b) of the process of the invention, the hydrogel is, if necessary, washed with water until the content of alkali metal ions is less than 0.1% by weight, based on the weight of solids. The residue content of alkali metal ions is preferably less than 0.05% by weight, particularly preferably less than 0.01% by weight. The washing of the hydrogel is carried out by generally known methods. Washing is preferably carried out with weakly ammoniacal water having a temperature of from about 50° C. to 80° C. in a continuous countercurrent process. The residue sodium content can be determined, for example, by atomic absorption spectroscopy.

In a preferred embodiment, the hydrogel particles can optionally be subjected to an aging step in the range from 1 hour to 100 hours, preferably in the range from 5 hours to 30 hours, before washing and/or after washing with the alkaline solution to enable pore volume, surface area and/or mean pore radius of the support to be set.

After extraction of the water from the hydrogel down to a water content of less than 5% by weight, based on the total content of liquid, in step c), the hydrogel is finally dried in step d) to form a xerogel. For the purposes of the invention, drying is the removal of the solvent from the gel.

Drying of the finely particulate hydrogel can be carried out by all customary methods such as thermal drying, drying under reduced pressure or spray drying, with a combination of various methods also being possible. For example, the spray-dried support particles can additionally be thermally dried.

The support particles in the form of xerogels generally have a spheroidal, i.e. ball-like, shape. The desired mean particle size of the supports can be varied within a wide range and can be matched to the use of the supports. The mean particle size of the supports can thus, for example, be set according to various processes of the polymerization.

The support particles preferably have a mean particle size in the range from 1 μm to 350 μm, preferably in the range from 30 μm to 150 μm and particularly preferably in the range from 40 μm to 100 μm. The support particles which can preferably be produced by means of spray drying particularly preferably have a mean particle size in the range from 30 μm to 90 μm, more preferably in the range from 40 μm to 70 μm, even more preferably in the range from 40 μm to 50 μm and very particularly preferably in the range from 40 μm to 55 μm.

Particular preference is given to from 70% by volume to 90% by volume of the support particles, preferably 80% by volume of the particles, based on the total volume of the particles, having a mean particle size in the range from ≧40 μm to ≦90 μm.

Support particles which are preferably used for polymerization in slurry polymerization processes preferably have mean particle sizes of up to 350 μm, preferably a mean particle size in the range from 30 μm to 150 μm. Support particles which are preferably used for polymerization in gas-phase fluidized-bed processes preferably have a mean particle size in the range from 30 μm to 120 μm. Support particles which are preferably used for polymerization in suspension processes preferably have a mean particle size in the range from 30 μm to 300 μm, and support particles which are preferably used for polymerization in loop processes preferably have a mean particle size in the range from 30 μm to 150 μm. Support particles which can be used, for example, for polymerization in fixed-bed reactors preferably have mean particle sizes of ≧100 μm, preferably ≧300 μm, more preferably in the range from 1 mm to 10 mm, particularly preferably in the range from 2 mm to 8 mm and even more preferably in the range from 2.5 mm to 5.5 mm.

Preference is given to from 10% by volume to 90% by volume of the support particles, based on the total volume of the particles, having a particle size in the range from ≧40 μm to ≦120 μm, and preference is given to from 30% by volume to 80% by volume of the particles, based on the total volume of the particles, having a particle size in the range from ≧30 μm to ≦70 μm. Particle sizes of the support particles in the range from ≧30 μm to ≦70 μm are preferred.

The support particles preferably have a particle size distribution in which ≧90% by volume, based on the total volume of the particles, of particles have a size in the range from ≧16 μm to ≦500 μm, ≧75% by volume of the particles have a size in the range from ≧32 μm to ≦200 μm and ≧30% by volume of the particles have a size in the range from ≧48 μm to ≦150 μm.

The support particles particularly advantageously have a low fines content after drying. For the purposes of the present invention the fines content of the support particles is the proportion of support particles which have a particle size of less than 25 μm, preferably less than 22 μm, particularly preferably less than 20.2 μm. It is advantageous for less than 5% by volume of the particles after drying, based on the total volume of the particles, to have a particle size in the range from >0 μm to ≦25 μm, preferably in the range from >0 μm to ≦22 μm, particularly preferably in the range from >0 μm to ≦20.2 μm. Preference is given to less than 3% by volume, particularly preferably less than 2% by volume, of the particles, based on the total volume of the particles, having a particle size in the range from >0 μm to ≦25 μm, preferably in the range from >0 μm to ≦22 μm, particularly preferably in the range from >0 μm to ≦20.2 μm. Greater preference is given to less than 5% by volume, preferably less than 2% by volume, of the particles, based on the total volume of the particles, having a particle size in the range from >0 μm to ≦10 μm.

Furthermore, preference is given to less than 30% by volume, preferably less than 20% by volume, particularly preferably less than 15% by volume, very particularly preferably less than 10% by volume, of the particles, based on the total volume of the particles, having a particle size in the range from >0 μm to ≦35 μm, preferably in the range from >0 μm to ≦32 μm.

The support particles prepared by this process have a pore volume which is preferably less than 1.6 ml/g; the support particles more preferably have a pore volume of less than 1.2 ml/g, particularly preferably in the range from 0.8 ml/g to 1.25 ml/g.

The support particles prepared have a pore diameter which is preferably less than 20 nm; the support particles more preferably have a pore volume of less than 15 nm, particularly preferably in the range from 5 nm to 13 nm.

The surface area of the inorganic support can likewise be varied within a wide range by means of the drying method, in particular by the spray drying process. Preference is given to producing particles of the inorganic support, in particular a product from a spray drier, which have a surface area in the range from 100 m²/g to 1000 m²/g, preferably in the range from 150 m²/g to 700 m²/g and particularly preferably in the range from 200 m²/g to 500 m²/g. Supports which can be used for polymerization preferably have a surface area in the range from 200 m²/g to 500 m²/g. The specific surface area of the support particles is based on the surface area of the support particles determined by means of nitrogen adsorption according to the BET technique.

The bulk density of the inorganic supports for catalysts is preferably in the range from 250 g/l to 1200 g/l, with the bulk density being able to vary depending on the water content of the support. The bulk density of water-comprising support particles is preferably in the range from 500 g/l to 1000 g/l, more preferably in the range from 600 g/l to 950 g/l and particularly preferably in the range from 650 g/l to 900 g/l. In the case of supports which comprise no water or have only a very low water content, the bulk density is preferably from 250 g/l to 600 g/l. The supports which can be prepared according to the invention are particularly useful as supports for olefin polymerization catalysts. These can be any type of catalysts, for example Phillips, Ziegler or metallocene catalysts.

The supports which can be prepared according to the invention are particularly suitable for preparing Phillips catalysts.

For the purposes of the present invention, a Phillips catalyst is a catalyst system comprising a support which can be prepared according to the invention, the element chromium and at least one element selected from among Mg, Ca, Sr, Ba, B, Al, Si, P, Bi, Sc, Ti, V, Mn, Fe, Co, Ni, Cu, Zn, Zr, Nb, Mo, Ru, Rh, Pd, Hf, Ta and W and also, if appropriate, one or more activators. Preference is given to using an element selected from among Mg, Ca, B, Al, P, Ti, V, Zr and Zn in addition to chromium. Particular preference is given to using Ti, Zr or Zn. It should be emphasized that combinations of the abovementioned elements are also possible according to the invention. The elements mentioned can be constituents of the hydrogel or can be applied by subsequent doping of xerogel particles. It should be emphasized that mixtures of compounds of the elements mentioned are also encompassed.

To prepare the Phillips catalysts, the xerogel particles are doped with chromium and, if appropriate, with further elements and are subsequently subjected to calcination. Doping can be carried out by all known methods, with the process described in PCT/EP2005/052681 being preferred for joint application to the support. Here, chromium is applied together with further elements from a homogenous solution to the support.

The calcination of the doped xerogel particles is carried out at temperatures of from 350 to 1050° C., preferably from 400 to 950° C. For the purposes of the present invention, calcination is the thermal activation of the catalyst in an oxidizing atmosphere, unless indicated otherwise, with the chromium compound applied being converted completely or partly into the hexavalent state, i.e. activated, if the chromium is not already present in the hexavalent state. The choice of calcination temperature is determined by the properties of the polymer to be prepared and the activity of the catalyst. The upper limit to it is imposed by the sintering of the support and the lower limit is imposed by the activity of the catalyst becoming too low. Calcination is preferably carried out at a temperature which is at least 20-100° C. below the sintering temperature. The influence of the calcination conditions on the catalyst are known in principle and are described, for example, in Advances in Catalysis, Vol. 33, page 48 ff. Calcination preferably takes place in an oxygen-comprising atmosphere. The intermediate obtained from step b) or c) is preferably activated directly in the fluidized bed by replacement of the inert gas by an oxygen-comprising gas and increasing the temperature to the activation temperature. The intermediate is in this case advantageously heated at the appropriate calcination temperature in a water-free gas stream comprising oxygen in a concentration of more than 10% by volume for from 10 to 1000 minutes, in particular from 150 to 750 minutes, and then cooled to room temperature, resulting in the Phillips catalyst to be used according to the invention. In addition to the oxidative calcination, a preceding or subsequent calcination under inert gas conditions can also be carried out.

Activation can be carried out in a fluidized bed and/or in a fixed bed. Preference is given to carrying out a thermal activation in fluidized-bed reactors.

The catalyst precursor can also be doped with fluoride. Doping with fluoride can be carried out during the preparation of the support, the application of the transition metal compounds or during activation. In a preferred embodiment of the preparation of the supported catalyst, a fluorinating agent is brought into solution together with the desired chromium compound and, if appropriate, further metal compound and the solution is applied to the support in step (a).

All documents cited are expressly incorporated by reference into the present patent application. All percentages in this patent application are by weight based on the total weight of the corresponding mixtures, unless indicated otherwise.

The invention is illustrated below with the aid of examples, without it being restricted thereto.

The following methods of determination were used:

The determination of the surface area, the pore radii and the pore volume of the support particles was carried out by means of nitrogen adsorption according to the BET Technique (S. Brunauer et al., Journal of the American Chemical Society, 60, pp. 209-319, 1939).

All samples were dried beforehand at 150° C. under reduced pressure for 4 hours. Part of the dried beads was subsequently milled and the pore volume was determined.

The determination of the water content in the solvent was carried out by Karl-Fischer titration.

### EXAMPLES

The following examples were carried out using silicon oxide-titanium oxide cogel; titanium content of the solid=2.5% by weight, based on titanium.

### Comparative Example A

The extraction of the hydrogel was carried out exclusively by means of continuous extraction with methanol. The procedure described in DE 25 40 279 A1 was employed. Here, 150 g of water-comprising hydrogel beads having a diameter of 5-25 mm were introduced into a glass cylinder which was provided at the bottom with a coarse glass frit. A constant, continuous solvent flow (methanol and isopropanol tables 1 and 2; methanol table 2) was fed onto the hydrogel beads from a reservoir located at a higher level. The flow rate was 300 ml/hour. The hydrogel beads were always covered with solvent during the entire experiment. This was achieved by means of a siphon-like construction. The water content of the outflowing solvent was determined at regular intervals by Karl-Fischer titration.

The extracted hydrogel was subsequently dried at about 80° C. under reduced pressure and the pore volume and the specific surface area were determined.

A pore volume of 2.18 ml/g (H₂O) was able to be achieved by the continuous method of comparative example A. The total extraction time was 8 hours. The results are shown in table 1.

### Example 1

At the beginning, the hydrogel was extracted batchwise with methanol in three cycles until a water content of 6% had been reached. For this purpose, 150 g of the water-comprising hydrogel beads from example 1 having a diameter of 5-25 mm were placed in a glass beaker and covered with at least the same amount of methanol. After the time indicated in table 1, all of the solvent was discarded and replaced by fresh, water-free methanol. The water content of the discarded solvent was checked by Karl-Fischer titration.

A continuous extraction was subsequently carried out in a manner analogous to comparative example A. The respective extraction times are shown in table 1. (b) and (c) denote batchwise and continuous extraction, respectively.

The total extraction time could be reduced to 4 hours, i.e. by 50%, by the combination of batchwise and continuous extraction.

### Example 2

Using a method analogous to example 1, firstly a batchwise extraction and subsequently a continuous extraction with methanol were carried out. The respective extraction times are shown in table 1.

Compared to example 1, a further reduction of 1 hour and 18 minutes in the extraction time was able to be achieved at the same pore volume of 2.16 ml/g (H₂O).

TABLE 1

| | | Example A | | | | | | |
|---|---|---|---|---|---|---|---|---|
| | | (comparative | | | | | | |
| Extraction | | example) | Extraction | | Example 1 | Extraction | | Example 2 |
| time | | [% H₂O] | time | | [% H₂O] | time | | [% H₂O] |
| 120 | min | — | 5 | min (b) | — | 6 | min (b) | — |
| 180 | min | — | 10 | min (b) | — | 12 | min (b) | 6.8 |
| 240 | min | — | 15 | min (b) | 6.0 | 24 | min (b) | 5.1 |
| 300 | min | — | 60 | min (c) | 4.2 | 60 | min (c) | 7.4 |
| 360 | min | — | 120 | min (c) | 2.1 | 120 | min (c) | 0.3 |
| 420 | min | — | 180 | min (c) | 0.8 | | | |
| 480 | min | 0.1 | 210 | min (c) | 0.8 | | | |

| | | | | | | |
|---|---|---|---|---|---|---|
| 8 | h | 4 | h | 3 cycles | 2 h 42 min | 3 cycles |

| | | | | | |
|---|---|---|---|---|---|
| Pore volume | 2.18 ml/g | Pore volume | 2.14 ml/g | Pore volume | 2.16 ml/g |

1. A process for preparing an essentially spherical support for olefin polymerization catalysts, which comprises:
a) preparing a hydrogel comprising a cogel of silicon oxide and at least one further metal oxide,
b) optionally, washing the hydrogel until the content of alkali metal ions is less than 0.1% by weight, based on the weight of solids,
c) extracting water from the hydrogel until the water content is less than 5% by weight, based on the total content of liquid, and
d) drying the hydrogel to form a xerogel,
wherein step (c) comprises:
(1) from two to five batchwise extractions with a first organic solvent which is at least partially miscible with water down to a water content of less than 50% by weight, followed by
(2) one continuous extraction with a second organic solvent which is at least partially miscible with water;
wherein each batchwise extraction has a duration of from 2 to 30 minutes.

2. The process of claim 1, wherein the batchwise extractions are carried out down to a water content of from 10 to 0.5% by weight.

3. The process of claim 1 wherein the continuous extraction is carried out down to a water content of less than 2% by weight.

4. (canceled)

5. The process of claim 1, wherein the batchwise extractions each have a duration of from 3 minutes to 20 minutes.

6. The process of claim 1 wherein the duration of the batchwise extractions is increased with decreasing water content.

7. The process of claim 1 wherein the first and second organic solvents differ.

8. The process of claim 7, wherein the second organic solvent has at least one carbon atom more or at least one branch, including the heteroatoms, more than the first organic solvent.

9. The process of claim 7 wherein the first organic solvent and the second organic solvent are selected independently from the group consisting of R¹OH, R²—CO—R³, and R²—O—R³, wherein R¹ is a branched or unbranched organic radical having 1-6 carbon atoms, and R², R³ are, independently of one another, a branched or unbranched organic radical having 1-4 carbon atoms.

10. The process of claim 9 wherein the organic radicals R¹, R², R³ of the second organic solvent together have at least one carbon atom more than the first organic solvent.

11. The process of claim 7, wherein the first organic solvent is selected from the group consisting of methanol, ethanol, isopropanol and n-propanol and the second organic solvent is selected from the group consisting of isopropanol, n-propanol, n-butanol, isobutanol and t-butanol.

12. The process of claim 1, wherein the hydrogel is a silicon oxide-titanium oxide cogel.

13. A process for preparing a catalyst for olefin polymerizations, which comprises preparing a xerogel according to the process of claim 1, doping the xerogel with a chromium compound and calcining the doped xerogel at temperatures of from 350 to 1050° C. under oxidating conditions.
